(19) United States
(12) Patent Application Publication
(10) Pub. No.: US 2011/0267929 A1
(43) Pub. Date: Nov. 3, 2011

(54) DUAL FACED CLOCK

(76) Inventor: Chaim Isaac Ishakis, Brooklyn, NY (US)

(21) Appl. No.: 12/772,274

(22) Filed: May 3, 2010

(51) Int. Cl. G04B 19/00; G04B 19/04; G04C 17/00

(52) U.S. Cl. 368/228; 368/223; 368/241; 368/242

(57) ABSTRACT

A clock comprising: a housing; a first face located on the housing; a front end, adjacent to the first face; a second face located on the housing and adjacent to the front end; a first time display located on the first face; a second time display located on the second face; a single control unit located in the housing, and in signal communication with the first time display and second time display; an angle α, defining the angle between the first face and the second face, and where the angle α is greater than 0° and less than 180°.

### TECHNICAL FIELD

The present invention relates to a clock, and more particularly to a clock with two display faces.

### BACKGROUND

Many households have two beds in one or more bedrooms, such as the master bedroom and/or the children's room or guest room. Many hotels offer the option of two beds in a room. Due to design, space or financial restrictions there may only be one night table or other surface between the two beds where a clock can be conveniently mounted or placed. With such a two-bed, one-clock arrangement, only individuals on a single side of the night table can readily see the clock's face. Individuals in the other bed must reorient the face of the clock in order to view same. This may prove frustrating or even difficult for older people or people with disabilities. Known solutions involve the use of projectors to indicate the time on the ceiling or wall, which introduces unnecessary light and is complicated or difficult to read from multiple positions within the room. Other solutions require the use of two clocks, which can waste considerable space and may not be synchronized, leading to confusion when disabling alarms, requiring additional time for configuration or set-up after a power outage or otherwise complicate clock interaction.

Thus there is a need for a device that overcomes the above listed and other disadvantages.

### SUMMARY OF THE INVENTION

The disclosed invention relates to a clock comprising: a housing; a first face located on the housing; a front end, adjacent to the first face; a second face located on the housing and adjacent to the front end; a first time display located on the first face; a second time display located on the second face; a single control unit located in the housing, and in signal communication with the first time display and second time display; an angle α, defining the angle between the first face and the second face, and where the angle α is greater than 0° and less than 180°.

### BRIEF DESCRIPTION OF THE DRAWINGS

The present disclosure will be better understood by those skilled in the pertinent art by referencing the accompanying drawings, where like elements are numbered alike in the figures, in which:

FIG. 1 is a perspective front view of a dual-sided clock;

FIG. 2 is a top perspective view of the dual-sided clock of FIG. 1;

FIG. 3 is a rear perspective view of the dual-sided clock of FIG. 1;

FIG. 4 is a bottom perspective view of the dual-sided clock of FIG. 1; and

FIG. 5 is a schematic view of the disclosed clock.

### DETAILED DESCRIPTION

In one embodiment, the disclosed clock is a single clock with two displays. It has a triangular shape that allows people to view it from many angles. An alternate embodiment has a pyramidal shape which increases vertical visibility. These shapes make the clock displays visible not only when a person is their bed but also when they are out and about their room. Both displays are synchronized, and the clock centrally manages all features such as alarm, radio or music and time adjustment.

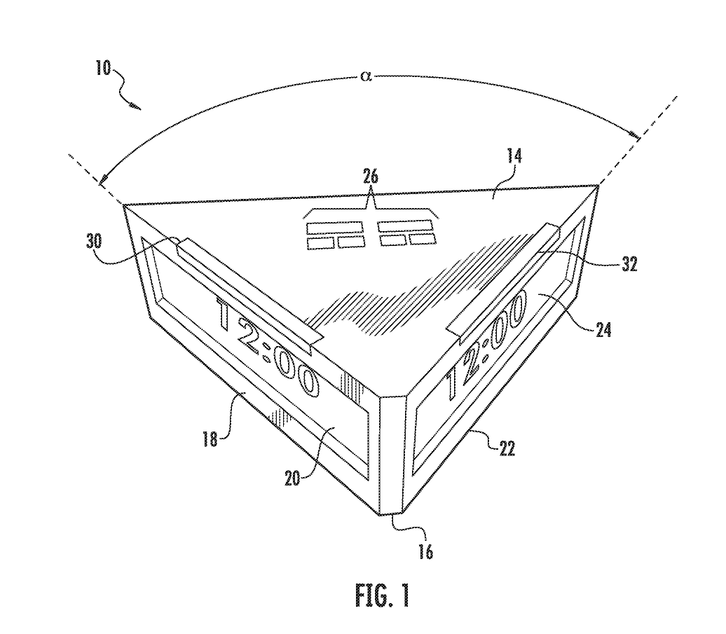

FIG. 1 is a top perspective view of one embodiment of the disclosed clock 10. The clock comprises a housing 14. The clock has a front end 16. The housing is configured to have at least a first face 18 and a second face 22 at an angle α with respect to one another. First face 18 has a time display 20. Second face 22 has a time display 24. The time shown on both time displays 20, 24 are identical, that is, if one face shows a time of 12:01 pm, the other face will also show the same time of 12:01 pm. The first face 18 and second face 22 are each adjacent to the front end 16. The angle α may range from about 10° to about 160°, and be preferably about 40° to about 120°. The housing 14 may also have clock controls 26, to control the setting of the time, setting the alarm, radio controls, etc. The controls may comprise buttons, switches, levers, and/or and touchpads. In addition, the housing 14 may also have at least one snooze control 30. In the embodiment shown in FIG. 1, there are two snooze controls 30, one adjacent to each of the two faces 18, 22. In other embodiments, the clock 10 may have only one snooze control 30. The snooze control 30 may comprise a button, switch, lever, and/or a touchpad.

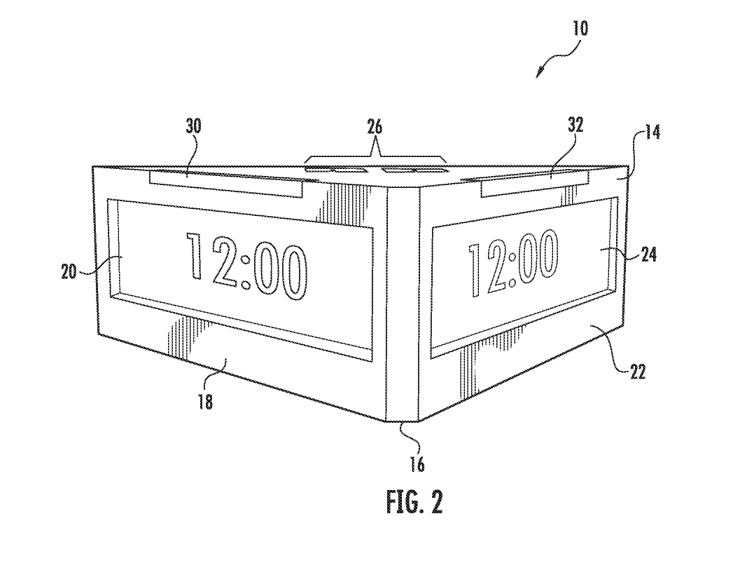

FIG. 2 is a front view of the disclosed clock 10.

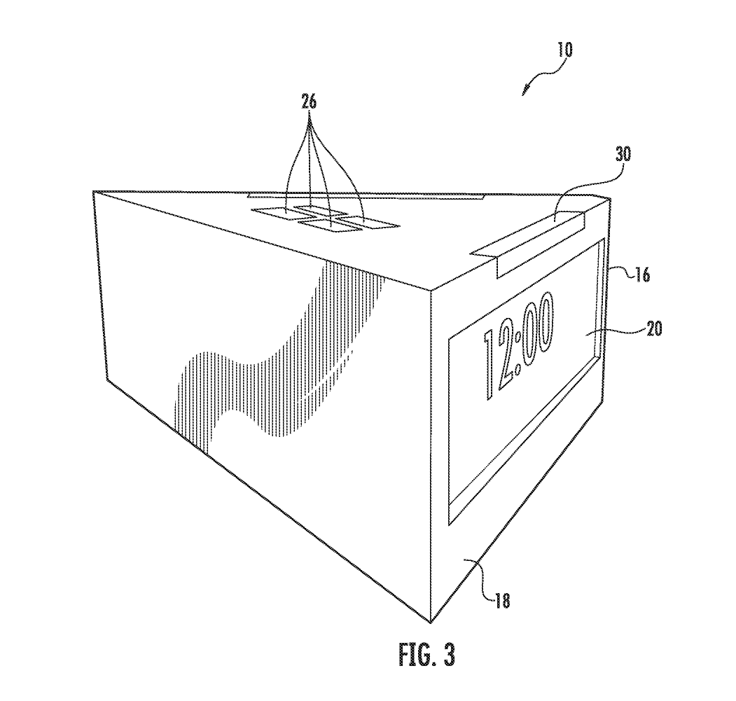

FIG. 3 is a side perspective view of the disclosed clock 10.

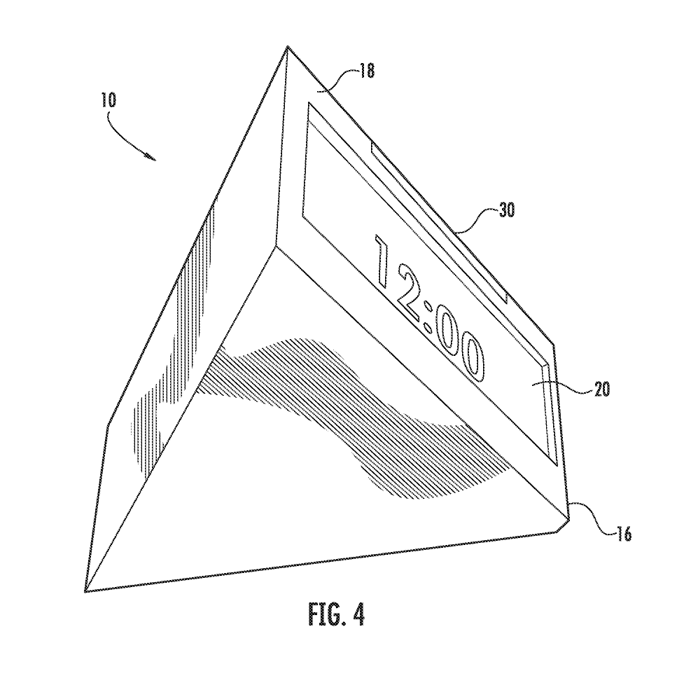

FIG. 4 is a bottom perspective of the disclosed clock 10.

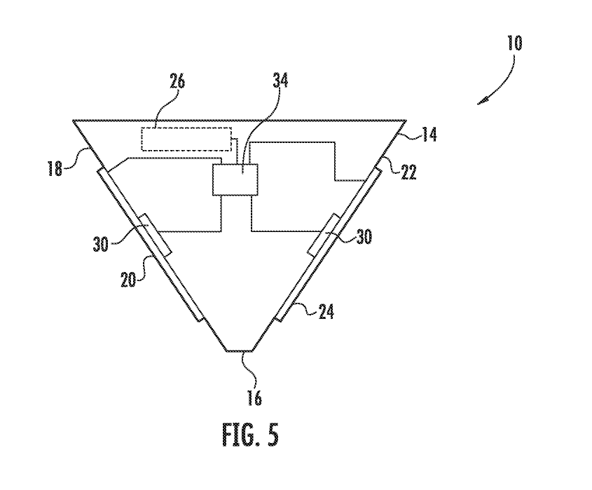

The time displays 20, 24, may also display “pm” and/or “am”, the date, temperature, time zone, indicate alarm status, am or fm radio, and/or the radio station currently playing. The clock 10, may be battery powered and/or ac powered. The time displays 20, 24 may be LED, LCD displays. In other embodiments, the time displays may comprise a traditional clock face and or clock dial with an hour hand, a minute hand, and/or a second hand. FIG. 5 discloses a schematic diagram of the disclosed clock 10. The clock 10 may comprise a single control unit 34 located in the housing 14. Control unit 34 has an internal clock, and with which both time displays 20, 24 are in signal communication with. In addition, the snooze controls 30 and the clock controls 26 are also in signal communication with the single control unit 34.

The disclosed clock has many advantages. It is a green device, that is, it saves energy and materials, by requiring only one clock to display the time in two directions, so that people on two beds, or in various locations in a room, can read the display. A single control unit controls the time shown on both displays, so that there will be no discrepancy between the time indicated on the two time displays. Only one power source is required to power the clock and its two faces. The disclosed clock will allow those in two-bed rooms, such as hotel rooms, to be easily able to tell the time from either bed, if the clock is located between the two beds.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A clock comprising:
a housing;
a first face located on the housing;
a front end, adjacent to the first face;
a second face located on the housing and adjacent to the front end;
a first time display located on the first face;
a second time display located on the second face;
a single control unit located in the housing, and in signal communication with the first time display and second time display;
an angle α, defining the angle between the first face and the second face, and wherein the angle α is greater than 0° and less than 180°.

2. The clock of claim 1, wherein the housing has a generally triangular shape.

3. The clock of claim 1, wherein the housing has a generally pyramidal shape.

4. The clock of claim 1, wherein the angle α is between 10° and 160°.

5. The clock of claim 1, wherein the angle α is between 40° and 120°.

6. The clock of claim 1, wherein the first time display and the second time display both comprise an LED display.

7. The clock of claim 1, wherein the first time display and the second time display both comprise an LCD display.

8. The clock of claim 1, wherein the first time display and the second time display both comprise a traditional clock face with an hour hand, and a minute hand.

9. The clock of claim 1, further comprising:
a first snooze control located on the housing, and adjacent to the first face; and
a second snooze control located on the housing, and adjacent to the second face.

10. The clock of claim 1, further comprising:
a clock control located on the housing, and in signal communication with the control unit.
